(19) United States
(12) Patent Application Publication
(10) Pub. No.: US 2023/0169564 A1
(43) Pub. Date: Jun. 1, 2023

(54) ARTIFICIAL INTELLIGENCE-BASED SHOPPING MALL PURCHASE PREDICTION DEVICE

(71) Applicant: TauData Co., Ltd., Seoul (KR)

(72) Inventor: Hwa-Min JEONG, Seoul (KR)

(73) Assignee: TauData Co., Ltd., Seoul (KR)

(21) Appl. No.: 17/536,869

(22) Filed: Nov. 29, 2021

(51) Int. Cl. G06Q 30/06; G06Q 30/02

(52) U.S. Cl. CPC G06Q 30/0631; G06Q 30/0204

(57) ABSTRACT

An artificial intelligence-based shopping mall purchase prediction device includes a memory and a processor electrically coupled to the memory. The processor collects product purchase data of a user object to build a data warehouse, adds a lifestyle characteristic to the data warehouse, builds a first characteristic data population, applies a statistical criterion to the first characteristic data population to determine at least one predictive independent variable among the characteristics of the product purchase data, builds a second characteristic data population, calculates a product purchase prediction degree by independently applying a plurality of artificial intelligence algorithms that apply a relatively high weight to the at least one predictive independent variable based on the second characteristic data population, and determines a product purchase prediction model associated with a highest product purchase prediction degree as an optimization model for the at least one predictive independent variable.

### BACKGROUND

The present disclosure relates to a technology for providing an artificial intelligence-based shopping mall purchase prediction platform, and more particularly, to an artificial intelligence-based shopping mall purchase prediction device that can predict a shopping mall purchase customer’s product purchase using an artificial intelligence algorithm.

In general, a recommendation system is a system for recommending filtered content from among a large amount of content to a user. As a recommendation method used by this recommendation system, for example, there are a collaborative filtering recommendation method which recommends content that users with similar personalities and tendencies as those of the user like in common, a content-based content filtering recommendation method which recommends other content with similar content information to the content previously used by the user, a demographic recommendation method which recommends content by analyzing demographic information to find rules, and the like.

Currently, there is insufficient scientific analysis of customers due to customer segmentation at the level of frequency analysis on the demographic characteristics and purchase patterns of shopping mall purchase customers, and product recommendation tends to be recommended based on marketing manager’s intuition or past behavior, and scientific product recommendation is not made. In order to solve the problems, it is necessary to shorten a search time of purchasing customers and develop an optimal shopping mall recommendation technology, which can enhance competitiveness of shopping mall operators.

### SUMMARY

The One embodiment of the present disclosure is to provide an artificial intelligence-based shopping mall purchase prediction device capable of predicting a shopping mall purchase customer’s product purchase using an artificial intelligence algorithm.

One embodiment of the present disclosure is to provide an artificial intelligence-based shopping mall purchase prediction device capable of subdividing product purchase data such as demographic characteristics, lifestyles, and symbolic consumption trends of shopping mall customers, and applying artificial intelligence algorithms to provide analysis of customer’s product purchase pattern and a product purchase prediction platform according to seasonal characteristics, timing characteristics, and purchase price fluctuations.

One embodiment of the present disclosure is to provide an artificial intelligence-based shopping mall purchase prediction device that can contribute to shortening a search time of purchasing customers and development of an optimal shopping mall recommendation technology, and thus, enhance competitiveness of shopping mall operators.

According to an aspect of the present disclosure, there is provided an artificial intelligence-based shopping mall purchase prediction device including: a memory; and a processor electrically coupled to the memory, in which the processor collects product purchase data of a user object for product purchase prediction of a user using a shopping mall to build a data warehouse, verifies a lifestyle of each user based on the product purchase data to add a lifestyle characteristic to the data warehouse, randomly extracts a plurality of characteristic data for each characteristic of the product purchase data in the data warehouse to build a first characteristic data population, applies a statistical criterion to the first characteristic data population to determine at least one predictive independent variable among the characteristics of the product purchase data, builds a second characteristic data population configured to overlap at least a portion of the first characteristic data population and obtained by randomly extracting the plurality of characteristic data only for the characteristic corresponding to the at least one predictive independent variable in the data warehouse, calculates a product purchase prediction degree by independently applying a plurality of artificial intelligence algorithms that apply a relatively high weight to the at least one predictive independent variable based on the second characteristic data population, and determines a product purchase prediction model associated with a highest product purchase prediction degree as an optimization model for the at least one predictive independent variable.

In this case, the product purchase data may include demographic characteristics, purchase season characteristics, purchase time characteristics, purchase price characteristics, and purchase product characteristics with respect to the user object.

The processor may determine any one of a fashion pursuit type, a happiness pursuit type, an information preference type, a foreign product preference type, and a cost performance preference type as a lifestyle characteristic defined in advance for each user, based on the product purchase data.

The processor may randomly extract n (n is a natural number) different characteristic data for each characteristic from the data warehouse to generate the first characteristic data population, apply the same artificial intelligence algorithm to each characteristic of the first characteristic data population to determine a characteristic that satisfies the statistical criterion as a candidate independent variable, and as a result of repeatedly determining the candidate independent variable for each of the plurality of artificial intelligence algorithms, finally determine the predictive independent variable according to the number of duplicates of the candidate independent variable.

The processor may first determine the predictive independent variable based on the number of duplicates of the candidate independent variable, and in the case where the first determined predictive independent variable is plural, when a correlation index between the predictive independent variables exceeds a threshold criterion, integrate the corresponding predictive independent variables into one through a calculation between the predictive independent variables.

The processor may integrate the corresponding predictive independent variables into one through the following Equation.

$$S = \frac{\sum {N}_{i}}{k} \times {\sum }_{i} log {C}_{i}$$

(Here, S is a result of integration of predictive independent variables, Ni is data of an i-th predictive independent variable, k is the number of predictive independent variables, and Cᵢ is a correlation index of the i-th predictive independent variable)

The processor may divide the second characteristic data population at a predetermined ratio to generate a learning data population and a verification data population, build a product purchase prediction model through learning about the predictive independent variable for the learning data population using each of the plurality of artificial intelligence algorithms, verify the verification data population using the product purchase prediction model, and determine, as an optimization model, a product purchase prediction model having a highest product purchase prediction degree as a result of the verification.

The processor may predict product purchase for a specific user based on the optimization model, and generate a list of recommended products for the specific user using a prediction result regarding the product purchase.

The processor may update weight of the optimization model based on a response of the specific user to the list of recommended products.

The disclosed technologies may have the following effects. However, this does not mean that a specific embodiment should include all of the following effects or only the following effects, and thus, a scope of the disclosed technology should not be construed as being limited thereby.

An artificial intelligence-based shopping mall purchase prediction device according to one embodiment of the present disclosure can subdivide product purchase data such as demographic characteristics, lifestyles, and symbolic consumption trends of shopping mall customers, and apply artificial intelligence algorithms to provide analysis of customer’s product purchase pattern and a product purchase prediction platform according to seasonal characteristics, timing characteristics, and purchase price fluctuations.

The artificial intelligence-based shopping mall purchase prediction device according to one embodiment of the present disclosure can classify a user’s purchasing propensity based on the result of a propensity test for product purchase performed when the user signs up for membership, then recommend a product that matches the purchasing propensity, and provide a product purchase prediction platform that can continuously improve the accuracy of product recommendation by reflecting whether to purchase the recommended product.

The artificial intelligence-based shopping mall purchase prediction device according to one embodiment of the present disclosure can contribute to shortening a search time of purchasing customers and development of an optimal shopping mall recommendation technology, and thus, enhance competitiveness of shopping mall operators.

### BRIEF DESCRIPTION OF THE DRAWINGS

FIG. 1 is a diagram for describing a configuration of a product purchase prediction system according to the present disclosure.

FIG. 2 is a block diagram describing a system configuration of the product purchase prediction device in FIG. 1.

FIG. 3 is a block diagram describing a functional configuration of the product purchase prediction device in FIG. 1.

FIG. 4 is a flowchart illustrating a process of providing an artificial intelligence-based product purchase prediction platform executed by the product purchase prediction device illustrated in FIG. 1.

FIG. 5 is an exemplary diagram illustrating an embodiment of a data warehouse used in the product purchase prediction system according to the present disclosure.

FIG. 6 is a conceptual diagram illustrating the overall operation of the product purchase prediction device according to the present disclosure.

### DETAILED DESCRIPTION

Descriptions of the present disclosure are merely embodiments for structural or functional description, and a scope of the present disclosure should not be construed as being limited by embodiments described here. That is, since the embodiments can have various changes and various forms, it should be understood that the scope of the present disclosure includes equivalents capable of realizing a technical idea. In addition, since objects or effects described in the present disclosure do not mean that a specific embodiment should include all of them or only the effects, it should not be understood that the scope of the present disclosure is limited thereby.

Meanwhile, the meaning of terms described in the present application should be understood as follows.

Terms such as “first” and “second” are for distinguishing one component from another, and the scope of rights should not be limited by these terms. For example, a first component may be referred to as a second component, and similarly, a second component may also be referred to as a first component.

When a component is referred to as being “coupled” to another component, the component may be directly connected to another component, but it should be understood that other components may exist therebetween. Meanwhile, when it is mentioned that a component is “directly coupled” to another component, it should be understood that other elements does not exist therebetween. Meanwhile, other expressions describing the relationship between components, that is, “between” and “immediately between” or “neighboring to” and “directly adjacent to”, or the like should be interpreted similarly.

The singular expression is to be understood to include the plural expression unless the context clearly dictates otherwise, and terms such as “include” or “have” refer to the embodied feature, number, step, action, component, part, or a combination thereof, and it should be understood that it does not preclude the possibility of the existence or addition of one or more other features or numbers, steps, operations, components, parts, or combinations thereof.

Identification codes (for example, a, b, c, or the like) in each step are used for convenience of description, the identification codes do not describe the order of each step, and each step may occur in a different order than the stated order unless the context clearly dictates a specific order. That is, each step may occur in the same order as specified, may be performed substantially simultaneously, or may be performed in the reverse order.

The present disclosure can be embodied as computer-readable codes on a computer-readable recording medium, and the computer-readable recording medium includes all types of recording devices in which data readable by a computer system is stored. Examples of the computer-readable recording medium include a read only memory (ROM), a random access memory (RAM), a compact disk read only memory (CD-ROM), magnetic tape, a floppy disk, an optical data storage device, and the like. In addition, the computer-readable recording medium may be distributed in a network-connected computer system, and the computer-readable code may be stored and executed in a distributed manner.

All terms used herein have the same meaning as commonly understood by one of ordinary skill in the art to which the present disclosure belongs, unless otherwise defined. Terms defined in the dictionary should be interpreted as being consistent with the meaning of the context of the related art, and cannot be interpreted as having an ideal or excessively formal meaning unless explicitly defined in the present application.

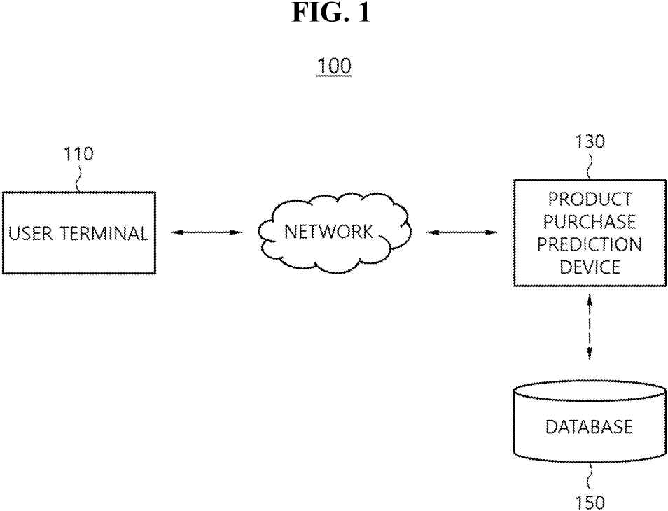

FIG. 1 is a diagram for describing a configuration of a product purchase prediction system according to the present disclosure.

Referring to FIG. 1, the product purchase prediction system 100 may include a user terminal 110, a product purchase prediction device 130, and a database 150.

The user terminal 110 may correspond to a computing device which can access an online shopping mall to purchase a product and receive a product recommendation through product purchase prediction and include a smartphone, a laptop computer, or a computer. However, the user terminal 110 should not be limited thereto and may be implemented in various devices such as a tablet PC. The user terminal 110 may be connected to the product purchase prediction device 130 through a network, and a plurality of user terminals 110 may be simultaneously connected to the product purchase prediction device 130.

The product purchase prediction device 130 collects data related to product purchase from users and analyzes the data to predict product purchase. Accordingly, the product purchase prediction device 130 may be implemented as a server corresponding to a computer or program that can provide optimized recommended products to users. The product purchase prediction device 130 may be wirelessly connected to the user terminal 110 through Bluetooth, WiFi, a communication network, or the like, and may exchange data with the user terminal 110 through the network.

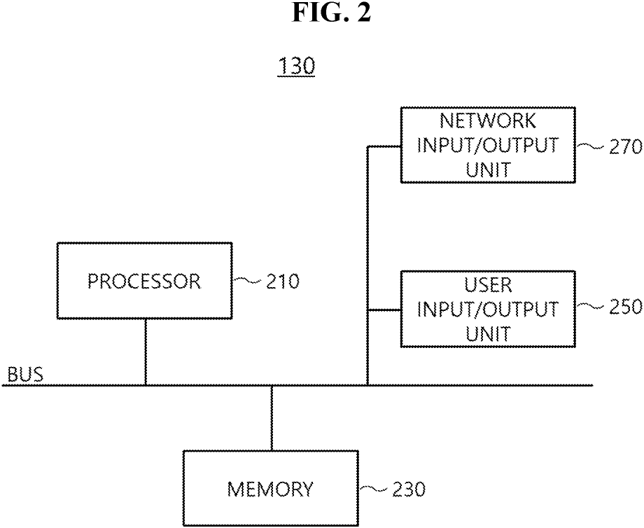

In one embodiment, the product purchase prediction device 130 may store data for product purchase prediction of a shopping mall purchasing customer in conjunction with the database 150. Meanwhile, the product purchase prediction device 130 may be implemented to include the database 150 therein, unlike FIG. 1. In addition, the product purchase prediction device 130 may be implemented to include a processor, a memory, a user input/output unit, and a network input/output unit, which will be described in more detail with reference to FIG. 2.

The database 150 may correspond to a storage device for storing various types of information required in the process of predicting product purchases of shopping mall customers and providing related information. The database 150 may store demographic information of a user collected from a plurality of user terminals 110 and store information on the product purchase in a shopping mall. However, the present disclosure is not necessarily limited thereto, and the database 150 may store information collected or processed in various forms in a process in which the product purchase prediction device 130 predicts product purchases and provides product recommendations.

FIG. 2 is a block diagram illustrating a system configuration of the product purchase prediction device in FIG. 1.

Referring to FIG. 2, the product purchase prediction device 130 may be implemented to include a processor 210, a memory 230, a user input/output unit 250, and a network input/output unit 270.

The processor 210 may execute a procedure for processing each operation in a process of predicting product purchase by collecting and analyzing the product purchase data of the shopping mall purchasing customer, manage the memory 230 that is read or written throughout the process, and schedule a synchronization time between a volatile memory and a nonvolatile memory in the memory 230. The processor 210 may control the overall operation of the product purchase prediction device 130, and is electrically connected to the memory 230, the user input/output unit 250, and the network input/output unit 270 to control data flow between them. The processor 210 may be implemented as a Central Processing Unit (CPU) of the product purchase prediction device 130.

The memory 230 may be implemented as a non-volatile memory, such as a solid state drive (SSD) or a hard disk drive (HDD), include an auxiliary storage device used to store overall data required for the product purchase prediction device 130, and include a main memory implemented as a volatile memory such as random access memory (RAM).

The user input/output unit 250 may include an environment for receiving a user input and an environment for outputting specific information to the user. For example, the user input/output unit 250 may include an input device including an adapter such as a touch pad, a touch screen, an on-screen keyboard, or a pointing device, and an output device including an adapter such as a monitor or a touch screen. In one embodiment, the user input/output unit 250 may correspond to a computing device accessed through remote access, and in such a case, the product purchase prediction device 130 may be performed as a server.

The network input/output unit 270 includes an environment for coupling with an external device or system through a network, and may include an adapter for communication such as a local area network (LAN), a metropolitan area network (MAN), a wide area network (WAN), and a VAN (Value Added Network).

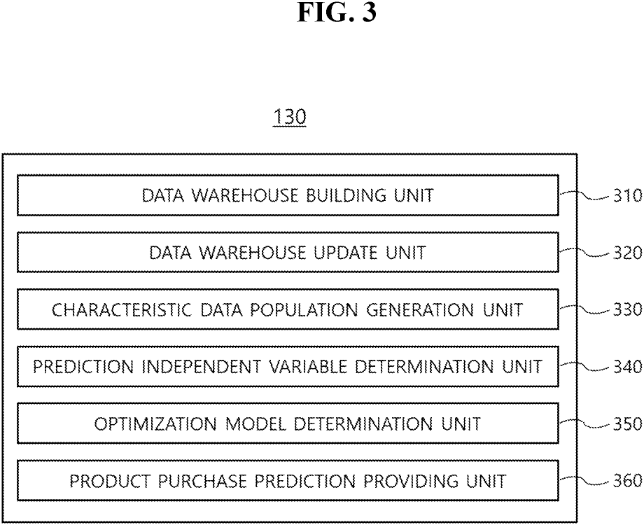

FIG. 3 is a block diagram describing a functional configuration of the product purchase prediction device in FIG. 1.

Referring to FIG. 3, the product purchase prediction device 130 includes a data warehouse building unit 310, a data warehouse updating unit 320, a characteristic data population generation unit 330, a predictive independent variable determining unit 340, an optimization model determination unit 350, a product purchase prediction providing unit 360, and a control unit (not illustrated in FIG. 3).

The data warehouse building unit 310 may build a data warehouse by collecting product purchase data of a user object for predicting product purchase of a user using a shopping mall. That is, the data warehouse building unit 310 may build the data warehouse by collecting product purchase data including demographic characteristics, purchase season characteristics, purchase time characteristics, purchase price characteristics, and purchase product characteristics of the user object. Here, the data warehouse may correspond to a database management system that collects and stores a series of related data generated while the user uses the shopping mall.

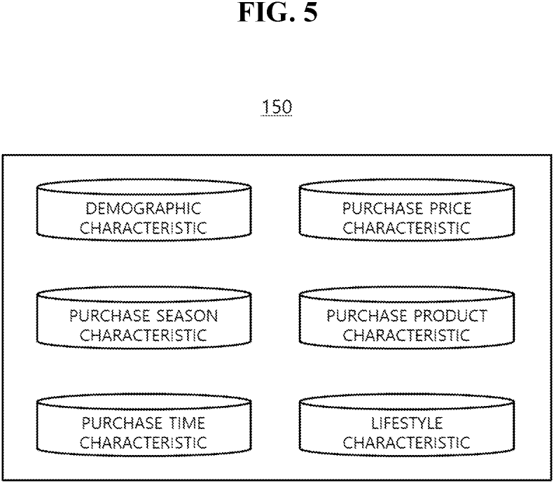

In this case, the database 150 of FIG. 1 may operate as a data warehouse, and a plurality of partial databases may be implemented in a form in which data is distributed and stored. In FIG. 5, data on the demographic characteristics, purchase season characteristics, purchase time characteristics, purchase price characteristics, purchase product characteristics, and lifestyle characteristics may be configured and stored as an independent data set for each characteristic by setting a user as an object in the database 150.

The demographic characteristics may include personal information on the user, for example, may include ID information, age, gender, residence, or the like as an identification code for user identification. The data warehouse building unit 310 may collect information related to demographic characteristics from the user terminal 110 of the user who uses the shopping mall, and based on the user information input during subscription or payment to the shopping mall, the data warehouse building unit 310 may collect information on the demographic characteristics, but the present disclosure is not necessarily limited thereto, and the dare warehouse building unit 310 may collect the demographic characteristics through various methods.

The purchase season characteristic is information on the user’s product purchase time, and may include seasonal information when the product purchase is made, the number of purchases per season, purchase amount per season, and the like. The purchase time characteristic is information on the user’s product purchase time, and may include time information when the product purchase is made, the number of purchases per hour, purchase amount per hour, and the like.

The purchase price characteristics are information on a product purchase price related to the product purchase, and may include a product purchase price, a discount price, a payment price, and the like. The purchase product characteristics are information on the product to be purchased, may include a product name, a brand name, a date of manufacture, an expiration date, capacity, a raw material, a product category (that is, fashion clothing/miscellaneous goods, beauty, maternity/children, food, kitchenware, household goods, interior, home appliance digital, sports/leisure, automobile supplies, books/records/DVDs, toys/hobbies, stationery/offices, companion animals, health/health food, or the like), and the lifestyle characteristics may correspond to a personal purchase pattern associated with the user’s product purchase, and may be predefined based on statistical information of product purchase data.

The data warehouse update unit 320 may verify the lifestyle for each user based on the product purchase data and add the verified lifestyle to the data warehouse as lifestyle characteristics. The data warehouse update unit 320 may verify the lifestyle for each user based on the product purchase data and add the verified lifestyle to the data warehouse as one piece of independent characteristic information. If necessary, the database 150 may build a separate partial database capable of storing lifestyle characteristics for each user separately from the previously built data warehouse. The data warehouse update unit 320 may verify the lifestyle for each user through various methods based on the product purchase data.

For example, the data warehouse update unit 320 may classify the data into at least one set by applying a clustering algorithm based on the product purchase data, and determine representative characteristics of the data for each set to associate the representative characteristics with any one of a plurality of predefined lifestyles. In addition, the data warehouse update unit 320 may obtain a classification result for lifestyle as an output by inputting an input vector generated based on product purchase data of a specific user to a classification model generated through machine learning.

In one embodiment, the data warehouse updater 320 may determine any one of a fashion pursuit type, a happiness pursuit type, an information preference type, a foreign product preference type, and a cost-effectiveness preference, as a lifestyle characteristic defined in advance for each user based on product purchase data. Here, the lifestyle characteristic may correspond to characteristic information on a personal life pattern that may affect the purchase of a product of the shopping mall purchasing customer.

The fashion pursuit type may correspond to a purchasing pattern in which a person pursues new things or selects a product to be purchased according to a trend, the happiness pursuit type may correspond to a purchase pattern that considers individual satisfaction as the top priority in product purchase or purchases products while enjoying shopping itself, and the information preference type may correspond to a purchasing pattern that selects the best product after evaluating and systematically organizing and searching various information on products through information collection, regardless of fashion or satisfaction.

In addition, when conditions are the same, the foreign product reference type may correspond to a purchasing pattern in which a person prefers a foreign product to a domestic product or purchases a well-known brand (foreign) product without careful search for product quality or attributes, and the cost performance preference type may correspond to a purchase pattern that determines product purchase in consideration of product value and cost.

In one embodiment, the data warehouse updater 320 may receive a survey response regarding the lifestyle characteristic from the user terminal 110 to determine the lifestyle characteristic. More specifically, when the membership registration process is detected on the user terminal 110, the data warehouse update unit 320 may provide a questionnaire regarding the lifestyle characteristics and receive a questionnaire response from the user terminal 110 to determine the lifestyle characteristics of the user.

In one embodiment, the questionnaire provided by the data warehouse updater 320 may be expressed as follows.
1) Fashion pursuit type
   When buy a product online, I tend to look at what is trending in advance.
   I tend to carefully look at the latest trends online and choose trendy products.
2) Happiness pursuit type
   I like to shop online.
   Purchasing products online gives me pleasure.
3) Information preference type
   I like to buy after seeing other people’s reviews online.
   I tend to buy after seeing the contents of the advertisement I saw online.
4) Foreign product preference type
   I prefer to buy foreign products online rather than domestic products.
   I tend to trust foreign products more than domestic products online.
5) Cost performance preference type
   When I buy products online, I tend to consider cost performance first.
   I tend to compare prices for various products online and then buy them.

The characteristic data population generation unit 330 may construct a first characteristic data population by randomly extracting a plurality of characteristic data for each characteristic of the product purchase data in the data warehouse. Here, the first characteristic data population may include characteristic data randomly selected from among product purchase data stored in the data warehouse, and may correspond to learning data used for learning for the product purchase prediction. The characteristic data population generation unit 330 may basically randomly extract data from the data warehouse, may set a predetermined search criterion as necessary, and may extract the searched data according to the search criterion.

For example, with respect to food purchases, the demographic characteristics of the first characteristic data population may include characteristic data regarding a gender (for example, male and female), an age (for example, 10’s, 20’s, 30’s, 40’s, 50’s, 60’s, or more), an address (Seoul, metropolitan area (excluding Seoul), other regions, or the like), an occupation (for example, student, office worker, self-employed, housewife, or the like), an income (monthly income) (for example, less than 190 million won, 190 to 250 million won, 250 to 400 million won, 400 to 500 million won, more than 500 million won, or the like), and a frequency of online purchases (on a monthly basis) (for example, 0, 1 to 3 times, 3 to 5 times, 5 or more times, or the like) of a purchasing user by food, the purchase season characteristics may include characteristic data regarding the season in which the purchase of each food occurs, and the purchase time characteristics may include characteristic data regarding a time, date, day of the week, or the like in which the purchase of each food occurs. In addition, the purchase price characteristic may include characteristic data regarding the number of purchases, capacity, price, and the like for each food, and the purchase product characteristic may include characteristic data regarding a type, a material, recipe, and the like for each food.

In one embodiment, the characteristic data population generation unit 330 may generate the first characteristic data population by randomly extracting n (n is a natural number) different characteristic data for each characteristic from the data warehouse. For example, the characteristic data population generation unit 330 may extract n1 pieces of characteristic data for the first characteristic, n2 pieces of characteristic data for the second characteristic, and n3 pieces of chrematistic data for the third characteristic. In this case, n1, n2, and n3 may be applied as different values during the data extraction process.

The predictive independent variable determination unit 340 may determine at least one predictive independent variable among the characteristics of the product purchase data by applying a statistical criterion to the first characteristic data population. That is, the predictive independent variable determination unit 340 may determine, as the predictive independent variable, a significant independent variable that can influence the product purchase prediction based on randomly selected data from among product purchase data stored in the data warehouse, as the predictive independent variable, and selectively extract only the data corresponding to the predictive independent variable to use the extracted data for the product purchase prediction. Accordingly, it is possible to improve accuracy of the product purchase prediction.

More specifically, the predictive independent variable determination unit 340 may set and use the statistical criteria in advance to select the predictive independent variable, and in this case, and the statistical criterion may be used to determine an independent variable that can have a significant effect on the actual user’s product purchase process among various independent variables included in the product purchase data. Accordingly, the predictive independent variable determination unit 340 compares a statistical value derived for each independent variable of the first characteristic data population with a statistical criterion, and only when predetermined conditions are satisfied, the statistical value may be determined as the predictive independent variable.

In one embodiment, the predictive independent variable determination unit 340 may determine a characteristic satisfying the statistical criterion as a candidate independent variable by applying the same artificial intelligence algorithm to each characteristic of the first characteristic data population, and as a result of repeatedly determining the candidate independent variable for each of the plurality of artificial intelligence algorithms, the predictive independent variable can be finally determined according to the number of duplicates of the candidate independent variable.

More specifically, the predictive independent variable determination unit 340 may determine, as the candidate independent variable, a characteristic satisfying a statistical criterion by applying the same artificial intelligence algorithm to the previously generated first characteristic data population. Next, the predictive independent variable determination unit 340 may repeatedly perform an operation of determining the candidate independent variable for each of the plurality of artificial intelligence algorithms, and may finally predict the predictive independent variable based on the number of duplicates of the candidate independent variable determined by repetition. That is, an independent variable repeatedly determined a predetermined number of times or more as the candidate independent variable in an iterative process may be finally determined as the predictive independent variable.

The predictive independent variable determination unit 340 may repeatedly perform the operation of determining the candidate independent variable, and for this purpose, the predictive independent variable determination unit 340 may be implemented to include independent modules that perform the operation of each step performed in the iterative process.

In one embodiment, the predictive independent variable determination unit 340 may finally determine the predictive independent variable based on the number of duplicates of the candidate independent variable determined by an iterative operation and a correlation index between the independent variables. Here, the correlation index between the independent variables may be expressed as multicollinearity between the independent variables. That is, the predictive independent variable determination unit 340 may first determine the predictive independent variable based on the number of duplicates of the candidate independent variable, and when the correlation index among the firstly determined predictive independent variables exceeds the threshold criterion, the predictive independent variable determination unit 340 may finally determine only one of the corresponding predictive independent variables. In this case, the correlation index between the independent variables may be measured through a variation inflation factor (VIF), a tolerance limit, a state index (CN), or the like.

In one embodiment, the predictive independent variable determination unit 340 may first determine the predictive independent variable based on the number of duplicates of the candidate independent variable, and in a case where the firstly determined predictive independent variable is a plurality of predictive independent variables, when the correlation index between the predictive independent variables exceeds the threshold criterion, the predictive independent variable determination unit 340 may integrate the corresponding predictive independent variables into one through the calculation between the corresponding predictive independent variables. In this case, the integration between the corresponding predictive independent variables may be performed through the calculation between the predictive independent variables, and a preset function may be used in the calculation process.

In one embodiment, the predictive independent variable determination unit 340 may integrate the corresponding predictive independent variables into one through the following Equation 1.

$$S = \frac{\sum {N}_{i}}{k} \times {\sum }_{i} log {C}_{i}$$

Here, S is a result of the integration of the predictive independent variables, Ni is data of an i-th predictive independent variable, k is the number of predictive independent variables, and Cᵢ is a correlation index of the i-th predictive independent variable. That is, the predictive independent variable determination unit 340 may derive an integrated result by calculating a log average of the correlation index for the predictive independent variables with the total data of all predictive independent variables.

In one embodiment, the predictive independent variable determination unit 340 may apply the same artificial intelligence algorithm to each characteristic of the first characteristic data population, and in this case, a significance level is set to 0.05 as a statistical criterion. Moreover, when a significance probability p of the specific characteristic is less than the significance level, it can be determined that the particular characteristic satisfies the statistical criterion. Here, the significance level may correspond to the maximum value of the probability of making a type I error in statistical determination, and may be expressed as α. The significance probability p may correspond to the minimum probability of rejecting a null hypothesis (hypothesis to be verified) with respect to current data. Therefore, in a case where the significance level α is set to 0.05, when the calculated significance probability p is less than 0.05, the null hypothesis is rejected and an alternative hypothesis (the hypothesis that is the opposite of the null hypothesis and is a subject of argument) may be adopted.

More specifically, the predictive independent variable determination unit 340 may set the significance level to 0.05 as the statistical criterion and compare the significance probability p with the significance level by applying the artificial intelligence algorithm for each characteristic to the first characteristic data population to drive the significant variable as the candidate independent variable. As a result, the significant variable may be a major variable affecting the shopping mall user’s product purchase prediction and determined according to a statistical criterion and the first characteristic data population.

In one embodiment, the predictive independent variable determination unit 340 may use any one of a logistic regression, a decision tree, and an artificial neural network as the artificial intelligence algorithm.

The logistic regression is a probabilistic model proposed by D.R.Cox and may correspond to a statistical technique used to predict the probability of an event using a linear combination of independent variables. A purpose of the logistic regression is to express the relationship between a dependent variable and an independent variable as a specific function and use the specific function for future prediction models, similar to the goal of a general regression analysis. Unlike a linear regression analysis, since the dependent variable targets categorical data and the result of the corresponding data is divided into a specific classification when input data is given, the logistic regression may correspond to a kind of classification technique.

The predictive independent variable determination unit 340 may configure the dependent variable as categorical data as dichotomous data of 0 (do not buy) and 1 (buy), and in this case, the dependent variable is the probability of an event, and the predicted value may be expressed limitedly between 0 and 1. In addition, as a formula in the graph, when the data on the independent variables (demographic characteristics, purchase season characteristics, purchase time characteristics, purchase price characteristics, purchase product characteristics, and lifestyle characteristics) is changed by 1, the predictive independent variable determination unit 340 may derive values having a significance probability p of less than 0.05 as the significant variables based on the magnitude of influence on the dependent variable and an Exp(B) value, which is the probability that the event will occur.

The decision tree may correspond to a predictive model that connects an observation value and a target value for a certain item, and may correspond to one of the predictive modeling methods used in statistics, data mining, and machine learning. The predictive independent variable determination unit 340 may classify the purchasing customers in consideration of relevance and similarity between the data using the behavior related data of the purchasing customers.

For example, the analysis algorithm is a chi-squared automatic interaction detection method, and chi-squared quantity or F-test can be used regardless of the quantitative or qualitative dependent variable. The predictive independent variable determination unit 340 may select a parent node having a large chi-square statistic and the significant probability p < 0.05 as a useful variable forming a child node.

The artificial neural network may correspond to a statistical learning algorithm inspired by a neural network in biology (especially the brain in the central nervous system of an animal) in machine learning and cognitive science, and may correspond to a model in which artificial neurons (node) forming a network by combining synapses change the binding strength of synapses through learning so as to have problem-solving ability.

The predictive independent variable determination unit 340 may analyze complex, nonlinear, and relational multivariate data using an artificial neural network, predict the probability of occurrence in a specific future situation, or estimate a specific behavior of a customer. The predictive independent variable determination unit 340 may perform a detailed analysis through the following steps. (i) The predictive independent variable determination unit 340 may randomly divide the data of the data warehouse into 70% of learning data and 30% of verification data.

In addition, (ii) the predictive independent variable determination unit 340 may generate, as a data input covariate variable, a network diagram according to the corresponding covariate variable using the demographic characteristics, the purchasing season characteristics, the purchase time characteristics, or the like of the shopping mall user. (iii) The predictive independent variable determination unit 340 may apply a hyperbolic tangent function as an activation function to a hidden layer and apply a Softmax function as an activation function to an output layer. In this case, a synaptic weight in the diagram may mean a relation between a given layer and the next layer.

In addition, (iv) the predictive independent variable determination unit 340 may generate a receiver operating characteristic curve (ROC curve) by R programming, and may extract a ratio between the learning data and the verification data for confirming the importance analysis result of the independent variable and accuracies thereof. (v) The predictive independent variable determination unit 340 may determine a variable drawn with a thick solid line in the hidden layer for each variable of the network diagram as the candidate independent variable to derive the candidate independent variable.

The optimization model determination unit 350 may build a second characteristic data population configured to overlap at least a portion of the first characteristic data population, the second characteristic data population being obtained by randomly extracting the plurality of characteristic data only for the characteristic corresponding to the at least one predictive independent variable in the data warehouse, calculate a product purchase prediction degree by independently applying a plurality of artificial intelligence algorithms that apply a relatively high weight to the at least one predictive independent variable based on the second characteristic data population, and determines a product purchase prediction model associated with the highest product purchase prediction degree as an optimization model for at least one predictive independent variable.

More specifically, the optimization model determination unit 350 may generate the second characteristic data population for determining the optimization model by newly updating the first characteristic data population used to determine the predictive independent variable. In this case, the second characteristic data population may include at least a portion of the characteristic data included in the first characteristic data population in duplicate, and an update operation may be performed only on characteristics corresponding to the predictive independent variable. That is, the optimization model determination unit 350 may increase the distribution of data associated with a significant variable, and thus, may determine the optimization model with high accuracy in the product purchase prediction of the user.

In addition, the optimization model determination unit 350 may give the higher weight to the predictive independent variable in the process of applying the artificial intelligence algorithm to the second characteristic data population, and thus, may increase a reflection rate of the predictive independent variable in the product purchase prediction. The optimization model determination unit 350 may determine, as the optimization model for the corresponding predictive independent variable, a product purchase prediction model illustrating the highest product purchase prediction degree as a result of applying the plurality of artificial intelligence algorithms to each predictive independent variable.

Here, the product purchase prediction model may correspond to a probability model that outputs a product purchase probability when a specific predictive independent variable is input, and the optimization model determination unit 350 may predict the product purchase based on the product purchase probability. The optimization model determination unit 350 may calculate a product purchase prediction degree for the product purchase prediction model by comparing a product purchase result predicted through the product purchase prediction model with a product purchase result that can be confirmed through actual product purchase data. In this case, the product purchase prediction degree may be calculated as a ratio of the number of matches to the number of predictions, and if necessary, normalization may be performed to have a value within a specific range.

In one embodiment, the optimization model determination unit 350 may build the second characteristic data population by repeatedly performing a process of randomly extracting a plurality of characteristic data from the data warehouse to generate a characteristic data population a predetermined number of times. In this case, the optimization model determination unit 350 overlaps at least a portion of the characteristic data population generated by the previous iteration for each iteration, and in this case, the data overlap ratio may be applied differently to each at least one predictive independent variable. In particular, the overlap ratio may be determined according to the priority of the predictor independent variable. For example, the higher the priority the predictor independent variable, the lower the overlap ratio.

In one embodiment, when the optimization model determination unit 350 randomly extracts the plurality of characteristic data from the data warehouse and repeatedly performs the process of generating the characteristic data population to build the second characteristic data population, the optimization model determination unit 350 may dynamically apply the number of iterations related to the iteration operation. For example, the optimization model determination unit 350 may apply a different number of iterations to each predictive independent variable, and may apply a different number of iterations to the candidate independent variable and the predictive independent variable. Moreover, the optimization model determination unit 350 may determine the number of iterations based on the total number of data for the data warehouse, the number of predictive independent variables, and the number of data for each of the first and second characteristic data populations.

As another example, the optimization model determination unit 350 may determine the number of iterations through the following Equation 2 regarding the ratio between the candidate independent variable and the predictive independent variable.

$$t = k \times \left({d}_{t} - {d}_{i}\right) \times log R$$

Here, t is the number of iterations, k is a proportionality coefficient, dt is the total number of data, di is the number of predictor independent variables, and R is the ratio between the candidate independent variable and the predictive independent variable.

In one embodiment, the optimization model determining unit 350 may divide the second characteristic data population at a predetermined ratio to generate a learning data population and a verification data population, build a product purchase prediction model through learning about the predictive independent variable for the learning data population using each of the plurality of artificial intelligence algorithms, verify the verification data population using the product purchase prediction model, and determines, as the optimization model, a product purchase prediction model having the highest product purchase prediction degree as a result of the verification.

In one embodiment, the optimization model determination unit 350 determines a split ratio of the learning data population and the verification data population for the second characteristic data population, based on the size of each of the first and second characteristic data populations, the number of artificial intelligence algorithms, and the number of predictive independent variables. More specifically, the optimization model determination unit 350 may determine the split ratio so that the sizes of the learning data population and the verification data population are similar as the size of each of the first and second characteristic data populations increases, the number of artificial intelligence algorithms increases, or the number of predictive independent variables increases.

For example, when a basic split ratio between the learning data population and the verification data population is 7:3, the optimization model determination unit 350 determines the split ratio so that the split ratio approaches 5:5 as the size of each of the first and second characteristic data populations increases, the number of artificial intelligence algorithms increases, or the number of predictive independent variables increases.

In one embodiment, the optimization model determination unit 350 may calculate the split ratio of the learning data population and the verification data population for the second characteristic data population based on the number of total characteristic data, the data ratio between characteristics, and the number of predictive independent variables. For example, when the basic split ratio between the learning data population and the validation data population is 7:3, the optimization model determination unit 350 may determine the split ratio so that the split ratio approaches 5:5 as the number of total characteristic data increases, the data ratio between characteristics is uniform, or the number of the predictive independent variables increases.

The product purchase prediction providing unit 360 may predict product purchase for a specific user based on the optimization model, and generate a list of recommended products for the specific user using the prediction result regarding product purchase. For example, when a specific user uses a shopping mall, the product purchase prediction providing unit 360 may predict whether a specific user will purchase a product for each product, and provide products with the highest probability of purchasing or predicted to be purchased by the user as recommended products. In this case, the product purchase prediction providing unit 360 may generate a product list related to recommended products and provide the product list to the user through the user terminal 110, and the user may determine whether to purchase the product by referring to the recommended product list.

In one embodiment, the product purchase prediction providing unit 360 may update the weight of the optimization model based on the response of the specific user with respect to the list of the recommended products. The product purchase prediction providing unit 360 may update the weight of the optimization model in a direction to reduce an error by comparing whether the product predicted through the optimization model is purchased and whether the user actually purchases the product with each other. In this case, a backpropagation algorithm may be used for weight update, and the backpropagation algorithm may be selectively applied according to an optimization model.

The control unit (not illustrated in FIG. 3) may control the overall operation of the product purchase prediction device 130, and may manage a control flow or a data flow between the data warehouse building unit 310, the data warehouse update unit 320, the characteristic data population generation unit 330, the predictive independent variable determination unit 340, the optimization model determination unit 350, and the product purchase prediction providing unit 360.

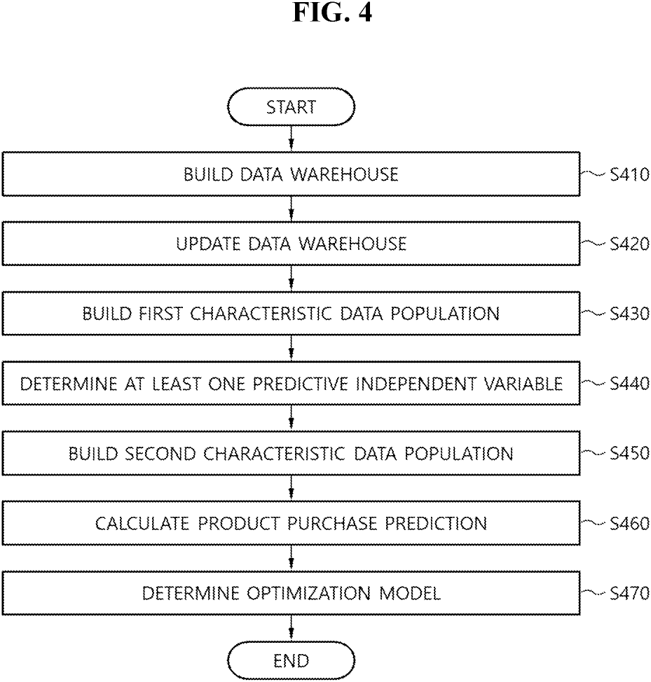

FIG. 4 is a flowchart illustrating a process of providing an artificial intelligence-based product purchase prediction platform performed by the product purchase prediction device illustrated in FIG. 1.

Referring to FIG. 4, the product purchase prediction device 130 may collect product purchase data of a user object for product purchase prediction of a user using a shopping mall through the data warehouse building unit 310 to build a data warehouse (Step S410). The product purchase prediction device 130 verifies the lifestyle of each user based on the product purchase data through the data warehouse update unit 320 and adds the lifestyle characteristic to the data warehouse to update the previously built data warehouse (Step S420). The product purchase prediction device 130 may build the first characteristic data population by randomly extracting a plurality of characteristic data for each characteristic of product purchase data in the data warehouse through the characteristic data population generation unit 330 (Step S430).

Moreover, the product purchase prediction device 130 may determine at least one predictive independent variable among the characteristics of the product purchase data by applying the statistical criterion to the first characteristic data population through the predictive independent variable determination unit 340 (Step S440). The product purchase prediction device 130 may build the second characteristic data population configured to overlap at least a portion of the first characteristic data population through the optimization model determination unit 350 and obtained by randomly extracting the plurality of characteristic data only for the characteristic corresponding to the at least one predictive independent variable in the data warehouse (Step S450), calculate the product purchase prediction degree by independently applying a plurality of artificial intelligence algorithms that apply a relatively high weight to the at least one predictive independent variable based on the second characteristic data population (Step S460), and determine a product purchase prediction model associated with the highest product purchase prediction degree as the optimization model for the at least one predictive independent variable (Step S470).

In one embodiment, the product purchase prediction device 130 may predict the product purchase for a specific user based on the optimization model through the product purchase prediction providing unit 360, and use the prediction result regarding the product purchase to create the list of recommended products for the specific user and recommend the list to the user.

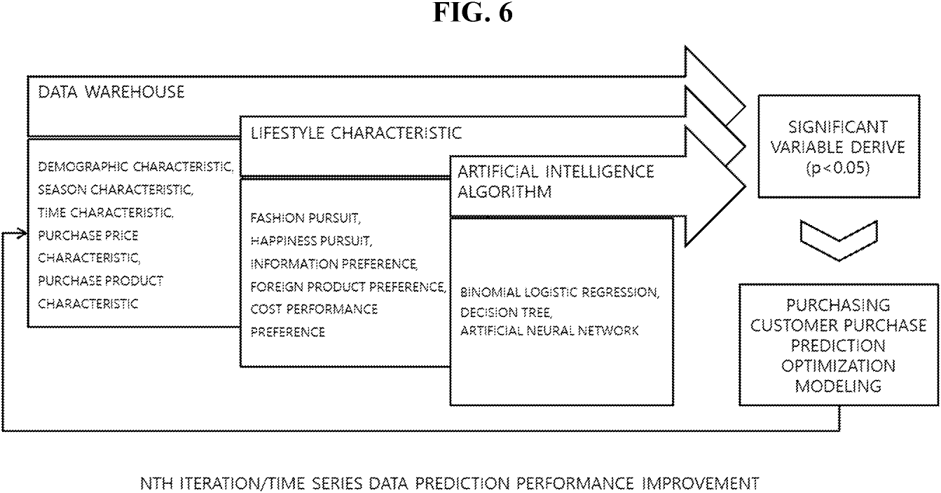

FIG. 6 is a conceptual diagram illustrating the overall operation of the product purchase prediction device according to the present disclosure.

Referring to FIG. 6, the product purchase prediction device 130 may build the data warehouse for product purchase prediction, and the data warehouse may collect and store data on the demographic characteristics, the purchase season characteristics, the purchase time characteristics, the purchase price characteristics, and the purchase product characteristics for each user object. To this end, the database 150 may include a plurality of partial databases, and may be stored and managed in a distributed manner through a network.

In addition, the product purchase prediction device 130 may verify the lifestyle for each user through the built data warehouse. In this case, an independent database for storing lifestyle characteristics may be built, and the data warehouse may be updated by adding the independent database to the previously built data warehouse. The product purchase prediction device 130 may derive the significant variable for product purchase prediction through various artificial intelligence algorithms and statistical criteria, and the significant variable may correspond to an independent variable that may affect the product purchase prediction.

The product purchase prediction device 130 may selectively utilize only the significant independent variables to increase the accuracy of product purchase prediction, and may repeatedly perform data collection, analysis, and modeling processes to build an optimization modeling. The product purchase prediction device 130 may select a model with the best product purchase prediction degree among artificial intelligence-based product purchase prediction platforms, and secure additional data several times until Nth times to increase the product purchase prediction rate of the user who uses the shopping mall.

Hereinbefore, although the present disclosure is described with reference to preferred embodiments of the present disclosure, those skilled in the art can variously modify and change the present disclosure within the scope without departing from the spirit and scope of the present disclosure as set forth in the claims below.

What is claimed is:

1. An artificial intelligence-based shopping mall purchase prediction device comprising:
a memory; and
a processor electrically coupled to the memory,
wherein the processor collects product purchase data of a user object for product purchase prediction of a user using a shopping mall to build a data warehouse,
verifies a lifestyle of each user based on the product purchase data to add a lifestyle characteristic to the data warehouse,
randomly extracts a plurality of characteristic data for each characteristic of the product purchase data in the data warehouse to build a first characteristic data population,
applies a statistical criterion to the first characteristic data population to determine at least one predictive independent variable among the characteristics of the product purchase data,
builds a second characteristic data population configured to overlap at least a portion of the first characteristic data population and obtained by randomly extracting the plurality of characteristic data only for the characteristic corresponding to the at least one predictive independent variable in the data warehouse,
calculates a product purchase prediction degree by independently applying a plurality of artificial intelligence algorithms that apply a relatively high weight to the at least one predictive independent variable based on the second characteristic data population, and
determines a product purchase prediction model associated with a highest product purchase prediction degree as an optimization model for the at least one predictive independent variable, and
the product purchase data includes demographic characteristics, purchase season characteristics, purchase time characteristics, purchase price characteristics, and purchase product characteristics with respect to the user object.

2. The artificial intelligence-based shopping mall purchase prediction device of claim 1, wherein the processor determines any one of a fashion pursuit type, a happiness pursuit type, an information preference type, a foreign product preference type, and a cost performance preference type as a lifestyle characteristic defined in advance for each user, based on the product purchase data.

3. The artificial intelligence-based shopping mall purchase prediction device of claim 1, wherein the processor randomly extracts n (n is a natural number) different characteristic data for each characteristic from the data warehouse to generate the first characteristic data population,
applies the same artificial intelligence algorithm to each characteristic of the first characteristic data population to determine a characteristic that satisfies the statistical criterion as a candidate independent variable, and
as a result of repeatedly determining the candidate independent variable for each of the plurality of artificial intelligence algorithms, finally determines the predictive independent variable according to the number of duplicates of the candidate independent variable.

4. The artificial intelligence-based shopping mall purchase prediction device of claim 3, the processor first determines the predictive independent variable based on the number of duplicates of the candidate independent variable, and
in the case where the first determined predictive independent variable is plural, when a correlation index between the predictive independent variables exceeds a threshold criterion, integrates the corresponding predictive independent variables into one through a calculation between the predictive independent variables.

5. The artificial intelligence-based shopping mall purchase prediction device of claim 4, wherein the processor integrates the corresponding predictive independent variables into one through the following Equation:
$$S = \frac{\sum {N}_{i}}{k} \times {\sum }_{i} log {C}_{i}$$
wherein, S is a result of integration of predictive independent variables, Ni is data of an i-th predictive independent variable, k is the number of predictive independent variables, and Cᵢ is a correlation index of the i-th predictive independent variable.

6. The artificial intelligence-based shopping mall purchase prediction device of claim 1, wherein the processor divides the second characteristic data population at a predetermined ratio to generate a learning data population and a verification data population,
builds a product purchase prediction model through learning about the predictive independent variable for the learning data population using each of the plurality of artificial intelligence algorithms,
verifies the verification data population using the product purchase prediction model, and
determines, as an optimization model, a product purchase prediction model having a highest product purchase prediction degree as a result of the verification.

7. The artificial intelligence-based shopping mall purchase prediction device of claim 1, wherein the processor predicts product purchase for a specific user based on the optimization model, and
generates a list of recommended products for the specific user using a prediction result regarding the product purchase.

8. The artificial intelligence-based shopping mall purchase prediction device of claim 7, wherein the processor updates weight of the optimization model based on a response of the specific user to the list of recommended products.
